(19) United States
(12) Patent Application Publication
(10) Pub. No.: US 2017/0091864 A1
(43) Pub. Date: Mar. 30, 2017

(54) Liquidity Position Score

(71) Applicants: Joseph Rulison, Rochester, NY (US); Peter Forsgren, Fairport, NY (US)

(72) Inventors: Joseph Rulison, Rochester, NY (US); Peter Forsgren, Fairport, NY (US)

(21) Appl. No.: 14/870,107

(22) Filed: Sep. 30, 2015

(51) Int. Cl. G06Q 40/06

(52) U.S. Cl. CPC G06Q 40/06

(57) ABSTRACT

three+one's Liquidity Position Score (branded and trademarked as cashVest score) is a proprietary, systematic method of evaluating the cash position of a municipality or higher education institution (colleges and universities). Organizations that are issued a score will receive 0 to 5 “stars” for five specific criteria, which will then be factored into an overall score that ranges from 0 to 100. Each of the five criteria are directly related to the entity's historical and current cash position. The Liquidity Position Score as a whole will help organizations determine their strengths and weaknesses when it comes to their cash position, and serve as benchmarks for evaluating progress.

### BACKGROUND OF THE INVENTION

Definitions critical to the context and descriptions within the patent application:
three+one—refers to three+one company, LLC.
Liquidity—Refers to cash and investments that can be easily converted to cash (i.e. U.S. treasuries, commercial paper, GNMA bonds) belonging to an entity.
cashVest score/cashVest—the branded, trademarked name for the “Liquidity Position Score” referenced in the title.
“Long-term”—when referring to cash/dollars/investable balances, it is describing them as having a duration of 1 year or greater.

### COMPANY BACKGROUND

three+one traditionally has served public entities (i.e. cities, counties, towns) and higher education institutions (i.e. colleges, universities) by helping them navigate the three major trends we see in the financial industry: 1) New banking technology, 2) Current and upcoming changes in banking regulations, and 3) The anticipation of higher interest rates. We do this by performing a complete analysis of the client's current treasury services, financial position, and cash flow patterns. Our analysis uses at least the most recent 12 months of banking transaction data. We then provide the client with a final report that gives them the best solutions specific to their organization, in the context of the three trends listed above. In addition, we seek to provide the client with quarterly cash flow updates.

Need for the Liquidity Position Score a.k.a. The cashVest Score

The financial crisis of 2008 left a permanent scar on the global economy. Entities of all types changed their behaviors regarding cash management because the economy entered dangerous and uncharted territory. This put a crucial need for entities to understand their exact liquidity needs and access to it. Some organizations truly needed to access their cash immediately after the crisis hit, while others drew on their cash reserves even though they did not need to, which added more stress to the financial system.

Unique to public entities and higher education institutions is the increased stability and predictability of their cash flow relative to other business entities. They have large receipts of cash that come at the same time every year (i.e. state/federal aid, tax revenue, tuition), and large obligations are planned and known well in advance. Although these entities need to be very conservative to ensure solvency during another financial crisis, understanding exactly what their cash position is and how their money can work better for them is critical to defending against another possible economic downturn.

Through the liquidity position score, three+one strives to ensure each client has every dollar working as efficiently as possible, while taking into account appropriate margins of safety. Due to the increased predictability of our client's cash flow, we are able to simulate extreme adverse conditions with confidence. When another financial crisis occurs, our clients will be able to withstand decreasing revenues while also meeting existing and future obligations.

Prior to the existence of three+one's liquidity position score, clients have been challenged in determining what levels of cash balances are appropriate for being identified as long term cash, what return they could be earning on excess balances, potential duration levels of cash balances, and what other factors influence increases or decreases in cash. While the balance sheet, income statement, statement of cash flows, and the annual budget are useful for evaluating past performance and planning ahead, they lack any detailed insight on historical cash patterns and future liquidity needs.

### BRIEF SUMMARY OF THE INVENTION

three+one provides a one-page liquidity position score to summarize what we have identified as the five primary influences on an entity's cash flow and cash position. The score gives the client a snapshot of strengths in their cash flow, and also areas that could be improved. An initial score is given after the first review of the client is performed (using the most recent 12 months of banking transaction data), and then subsequent scores are issued to the client quarterly, based on quarterly updates of banking transaction data.

Each section of the score is assigned a number of stars, from zero to five stars. Each star is worth 20 “points,” within each category, and three+one issues section scores in increments of half stars. The final score, found in the top right hand corner of the score sheet, is based upon a scale of 0 to 100, and is based upon a weighted average of the scores for each of the five sections. The particular weights associated with each section will be specified below.

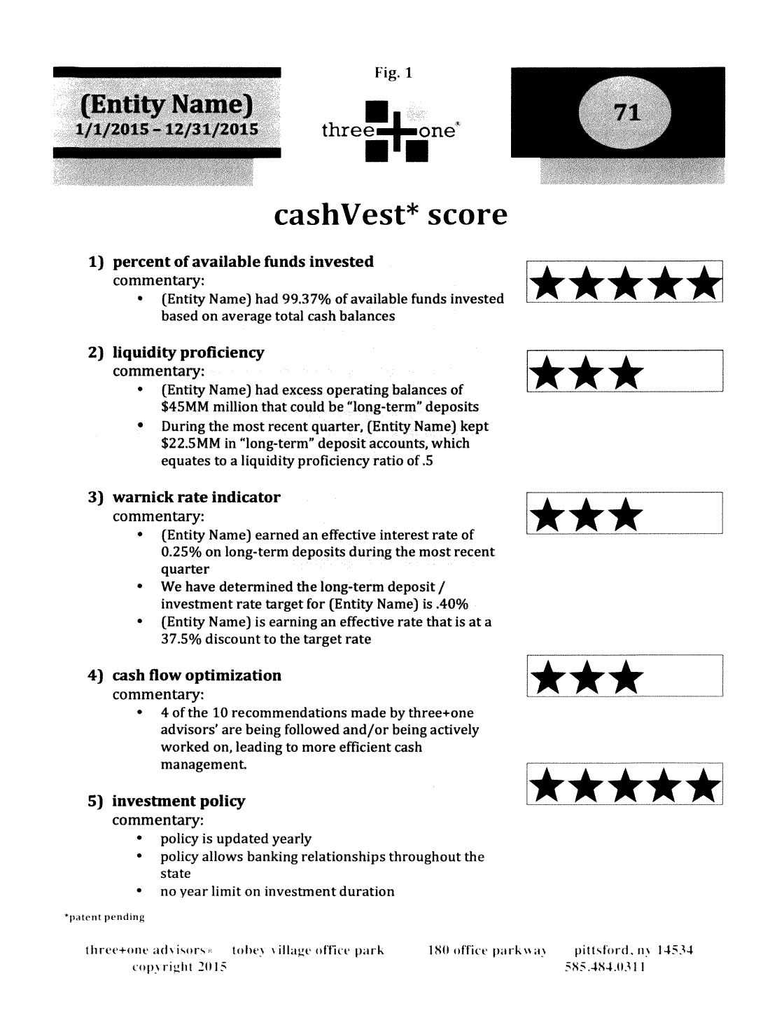

The five primary influences are as follows (brief descriptions of each aspect are included below, and more detailed descriptions will be provided in a subsequent section):
1) Percent of Available Funds Invested (Weight=25%)
   a. Refer to FIG. 1
   b. This is a ratio that takes the average amount of dollars that are earning an interest rate of any kind, and divides it by the total average cash balance of the entity during the time period being studied.
   c. Any dollars moved into a bank custody account through a third party advisor are considered to be invested, and are included in both the numerator and denominator of the formula.
2) Liquidity Proficiency (Weight=30%)
   a. Refer to FIG. 1
   b. This ratio is calculated by taking the average dollars kept in “long-term related accounts,” and dividing by the average dollars that should have been kept in “long-term related accounts.”
      i. “long-term related accounts” refers to money market deposit accounts or separate investment accounts.
         1. Although money market deposit accounts are overnight funds, we consider them to be “long-term” accounts for entities that have not had a cash flow analysis performed by three+one. Reason being, the funds that are in these accounts tend to remain unchanged for months, if not years at a time.
      ii. The denominator, a.k.a. “what should have been kept in ‘long-term related accounts,’” is calculated through thousands of cash flow simulations using Monte Carlo techniques, and will be described under the “Detailed Description of Invention” Section.
3) Warnick Rate Indicator (Weight=20%)
   a. Refer to FIG. 1
   b. This aspect of the score focuses only on annualized interest rates being earned on dollars identified as “long-term.” This indicator is not influenced by the amount of dollars designated as long-term by the entity, as this is already accounted for in the “Liquidity Proficiency” section described above.
   c. Interest rates are calculated to be an annualized rate on average balances. For any given period, the calculation of the annualized rate within a particular account is calculated as follows:
      i. (Total interest earned/Total average balance)*(12/number of months being analyzed)
         1. The above formula is annualizing the interest rate calculation using months, but it could be used with days, weeks, quarters, or years.
   d. This indicator will be calculated slightly differently for three+one's initial analysis, versus the calculation for when the client is being provided continuing services by three+one. The difference in calculations will be explained in the “Detailed Description of the Invention” section.
4) Cash Flow Optimization (Weight=15%)
   a. Refer to FIG. 1
   b. This part of the score only applies to clients who choose to have a treasury services analysis done on their operations, which is an additional fee on top of the base analysis. three+one will issue a report to the client regarding the findings of the analysis, and recommendations are given of actions to be taken that will improve the efficiency of the organization's cash flow and position. Our recommendations are designed to help our clients realize new sources of savings and revenue.
   c. We give a star rating based upon the percentage of recommendations given that are either in progress or completed. Any cashVest scores issued to a client who has not opted into a treasury services review through three+one will show an “N/A” where the star rating would go for this section. If the client does choose to have a treasury services review, then the initial cashVest score will have an “N/A” for this section, but subsequent score issuances will receive are star rating.
   d. Star ratings are based upon percentage ranges that shift based upon how far removed the client is from the initial report presentation. These ranges will be defined in the “Detailed Description of the Invention” section.
5) Investment Policy (Weight=10%)
   a. Refer to FIG. 1
   b. The evaluation of the client's Investment Policy Statement is the final aspect of three+one's liquidity position score. It is based upon 4 criteria:
      i. Frequency of policy updates and reviews (10% of the investment policy score, which equates to 1% of the total score)
      ii. Number of banks the client permits themselves to do business with (40% of the investment policy score, which equates to 4% of the total score)
      iii. Degree of restrictions and/or limits on investment duration (30% of the investment policy score, which equates to 3% of the total score)
      iv. Percent of allowable investments set forth by the entity's state that are permitted within the entity's investment policy statement (20% of the investment policy score, which equates to 2% of the total score)
         1. Every entity should have an investment policy statement that allows all investments permitted by their state (100%). There are some entities though that only permit 50% of the state's allowable investments, and three+one encourages they allow all state permitted investments.
      c. The specific ranges that determine the score for each individual section for the Investment Policy section will be explained in detail in the “Detailed Description of the Invention” Section.

Once all individual section scores are determined, a simple weighted average will be calculated to arrive at the final liquidity position score. A perfect score would equal 100, while the worst score would technically be a 0 (although unlikely, since we would only give 0 stars in a particular section if the client was being completely negligent in a particular area). After the weighted average is calculated, divide this answer by 5, and then multiply by 100. Round this answer to the nearest 0.5, and this will be the final score.

Final score calculation example:
1. Percent of Available Funds Invested—25% Weight: Score of 3 stars
2. Liquidity Proficiency—30% Weight: Score of 4.5 stars
3. Warnick Rate Indicator—20% Weight: Score of 2.5 stars
4. Cash Flow Optimization—15% Weight: Score of 3 stars
5. Investment Policy—10% Weight: Score of 5 stars
Final score calculation:

(0.25*3)+(0.3*4.5)+(0.2*2.5)+(0.15*3)+(0.1*5)=3.55 a.

(3.55/5)*100=71 b.

### BRIEF DESCRIPTION OF DRAWINGS

FIG. 1 is the one-page Liquidity Position Score that every three+one client receives. The following points are brief descriptions of each element within the drawing:
The overall Liquidity Position Score: This score is found in the top right hand corner of FIG. 1 (71). This is an example of where the overall score would be found for an entity. This number will be between 0 and 100, with 100 being the best possible score.
“percent of available funds invested”: This is found just under the title “cashVest*score,” about a quarter of the way down the page. This is the first element of the score, which describes what percent of available funds are invested or deposited, and also earning interest.
“liquidity proficiency”: This is found just below the “percent of available funds invested” section. This is the second element of the score, which describes what balances the entity can use for long-term deposits/investments, versus what is currently being designated as long-term by the entity.
“warnick rate indicator”: This is found just below the “liquidity proficiency” section. This is the third element of the score, which describes what the effective interest rate earned was over the period being studied, and also what discount or premium this rate is relative to a target rate set by three+one.
“cash flow optimization”: This is found just below “warnick rate indicator” section. This is the fourth element of the score, which is scored only if client's elect to have a treasury services review done by three+one. When three+one does a treasury services review, recommendations are given to the client that are designed to make their cash flow and cash position as efficient as possible. Stars are issued based upon how many recommendations have been implemented or are being worked towards.
“investment policy”: This is found just below the “cash flow optimization” section. This is the fifth and final element of the score, and is an evaluation of the client's investment policy.

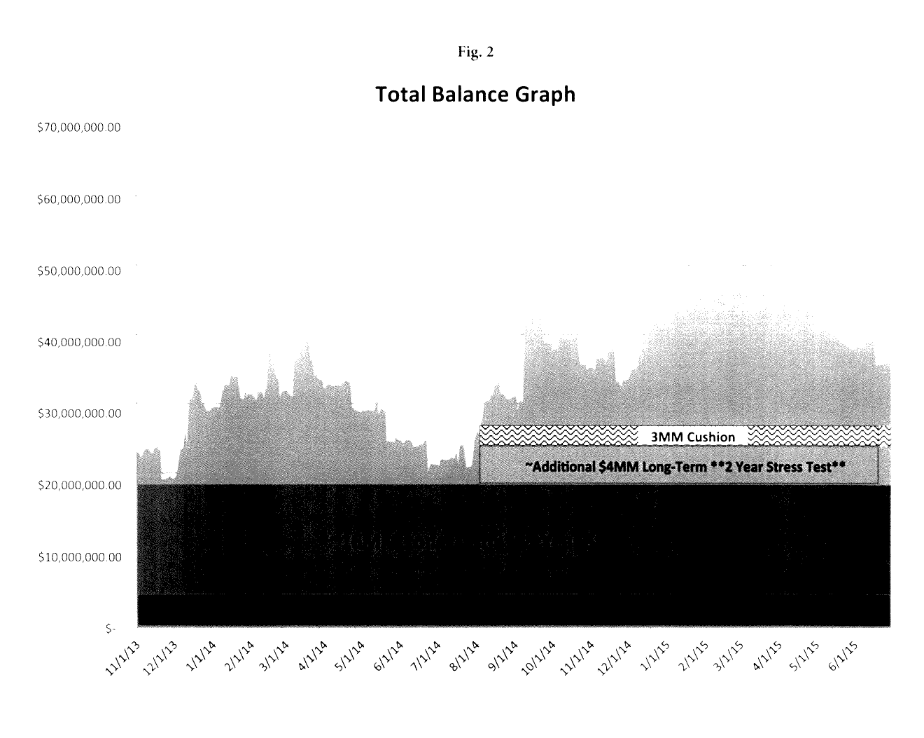

FIG. 2: This is an example of the total cash balance graph that three+one uses to support the liquidity position score issued to each client (provided with each score). The different areas of the graph are explained below.
“**5 Year Stress Test**”: This particular area is found at the bottom of the graph, and it specifies how many dollars pass our 5 Year Stress Test within our simulation models. This will vary from client to client, as it depends on each client's unique historical cash flow patterns. The amount shown in this bar typically is what we most strongly recommend our clients use for long-term investment first.
“**2 Year Stress Test**”: This particular area is found as a bar just above the 5 Year stress test area, and it specifies how many dollars pass our 2 Year Stress Test within our simulation models. This will vary from client to client, as it depends on each client's unique historical cash flow patterns. The amount shown in this bar is the next tier of money that we recommend clients have available for investment.
“3MM Cushion”: This area is a margin of safety found above the 2 Year Stress Test area that we refer to as the “cushion.” For this particular drawing, the cushion is $3 million, but it varies from client to client. This bar is typically the difference between the 2 year stress test amount and the 1 year stress test amount.
The remaining area above the cushion: This area refers to all other dollars that don't pass any of our stress tests and are therefore considered to be dollars used for daily operations.

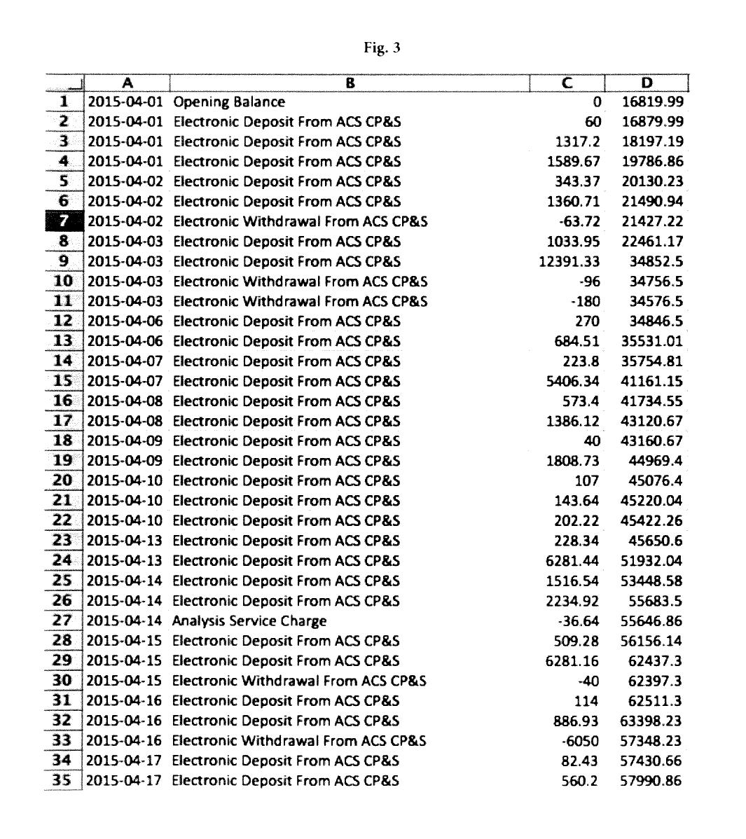

FIG. 3: This is a screenshot of a CSV file that contains bank statement transaction data to demonstrate the exact format in which the data must be uploaded into our database via our proprietary programs.
Column A shows the dates of the individual transactions. The dates must be in the exact form shown (YYYY-MM-DD).
Column B shows the transaction descriptions that were extracted from the bank statements.
Column C shows the transaction amounts.
Column D shows the updated account balance after that particular transaction was made.

### DETAILED DESCRIPTION OF THE INVENTION

three+one provides a one-page liquidity position score to summarize what we have identified as the five primary determinants of an entity's cash flow and cash position. The score gives the client a snapshot of strengths in their cash flow, and also areas that could be improved. An initial score is given after the first review of the client is performed (using the most recent 12 months of banking transaction data), and then subsequent scores are issued to the client quarterly, based on quarterly updates of banking transaction data.

Each section of the score is assigned a number of stars, from zero to five stars. Each star is worth 20 “points” within each category, and three+one issues section scores in increments of half stars. The final score, found in the top right hand corner of the score sheet, is based upon a scale of 0 to 100, and is based upon a weighted average of the scores for each of the five sections.

### How Data is Collected and Aggregated to Arrive at the Final Score

Although the data collection process itself is not a specific claim under this patent, it is useful knowledge to understand how the Liquidity Position Score is constructed. The steps for data collection and aggregation are as follows:
three+one advisors requests at a minimum the last 12 months of bank statements or bank transaction data for every account associated with the client. For Liquidity Position Score updates issued quarterly after the initial score issuance, only the most recent 3 months of bank statements or bank transaction data for every account is required (since this will simply be keeping their transaction data “up-to-date” in our systems). Bank statement data must be provided in electronically generated PDF form (no scanned documents) in order for us to complete our data aggregation process.
   If Bank transaction data is provided to three+one in .csv (comma separated values—can be opened with Microsoft Excel) or .xls (Microsoft Excel Workbook) format, then skip the next step and move to step 3.
If three+one receives PDF bank statements, then we must put them through a program that extracts the transactions from the statements and puts them in a “CSV”
Depending on the bank and/or the bank statements/transaction data provided, the actual format of the bank transactions in the CSV/Excel workbook files will typically vary. Therefore, it is necessary for analysts at three+one to organize the data in a particular fashion and order, described in the next step.
Bank transaction data must be organized in the exact format and saved as a CSV file, as shown in FIG. 3:
   Column A shows the dates of the individual transactions. The dates must be in the exact form shown (YYYY-MM-DD).
   Column B shows the transaction descriptions that were extracted from the bank statements.
   Column C shows the transaction amounts.
   Column D shows the updated account balance after that particular transaction was made.
   For any account being analyzed, the first row of the data should be as follows:
      i. Cell A1: The first day of the first month of transaction history, even if the first day of the month is on a weekend. For example, if client transaction data history were to start on May 3, 2014→Cell A1 would be 2014-05-01.
      ii. Cell B1: “Opening Balance”
      iii. Cell C1: “0”
      iv. Cell D1: The starting balance of that account.
three+one uploads all CSVs into our proprietary programs that aggregate all banking transactions into a database.
Once the bank transaction data is in our database, we can see the data aggregated in many different ways, for example:
   Total cash balances amongst all accounts for any given day
   Average total cash balances for any day, week, month, etc.
   Daily and weekly fluctuations in net cash positions. These are used for our proprietary cash flow simulations.
   Interest earnings associated with each account, which can then be used with average balances to derive an annualized interest rate being earned for every account, and for the entity as a whole.
      What Separates Three+One Advisors' Liquidity Position Score from Other Inventions/Prior Art to Date

The closest related score to three+one's Liqiuidty Position Score are credit ratings issued by companies like S&P Capital, Moody's, and Fitch Ratings. There are a number of key differences between these issued credit ratings, and the three+one Liquidity Position Score:
1. Credit Ratings focus on the subject entity's likelihood of default, while the Liquidity Position Score focuses primarily on cash balances available for investment, and the factors that influence changes in these available balances.
2. Credit Ratings look at the entity's balance sheet, income statement, and statement of cash flows to determine the financial health and stability of the entity. three+one's Liquidity Position Score, in contrast, focuses solely on cash balances, derived directly from the client's bank statements.
3. Credit Ratings take into account future prospects and forecasts of the entity when determining their overall credit score. While three+one does not ignore future prospects, the Liquidity Position score does not include any analyst forecasts or expectations of the entity. The “Liquidity Proficiency” section of the score does incorporate simulations of future cash position based upon historical data, but this is not considered to be a projection of the client's ability to make future payments, rather, it is simply a projection of an extreme “worst-case” scenario of cash balances.
4. While both Credit Ratings and three+one's Liquidity Position Score consider the subject entity's investment policy, the context and lens through which it is examined is very different. three+one is primarily concerned with how the entity's investment policy influences the management of cash balances.
5. three+one's Liquidity Position Score has a “Cash Flow Optimization” section, that attempts to incentivize the subject entity to improve banking technology tools available to them. three+one advisors believes that by improving technological capabilities (a.k.a. treasury services), cash “float” will improve, and thus increase cash available for investment. Traditional Credit Ratings do not consider technological capabilities of the entity at all, as it does not have as much relevance to the goals of the credit scores being issued.
   The Five Primary Determinants of the Liquidity Position Score, and how they are Calculated:
a. Percent of Available Funds Invested (Weight=25%)
   a. Refer to FIG. 1
   b. This is a simple ratio that takes the average amount of dollars that are earning an interest rate of any kind, and divides it by the total average cash balance of the entity during the time period being studied.
      i. (Sum of average balances that earned an interest rate)/(Total average cash balance)
   c. For example: An entity has 3 accounts (denoted A, B, and C), and their average balances for the previous year (or whatever time period is being studied) are as follows:
      i. A=$1,500,000
      ii. B=$2,000,000
      iii. C=$1,000,000
         1. Now suppose that only accounts B and C earned an interest rate during the year. The calculation would be as follows:
         a. $3,000,000/$4,500,000=67%
   d. For accounts that earned an interest rate for only a portion of the time period being studied, then the following rules are applied to see if the particular account's average balance will be counted as “invested” (the numerator of the ratio):
      i. If the account is earning an interest rate as of the most recent month's data, then count it as “invested.”
      ii. If the account is not earning an interest rate as of the most recent month's data, then apply the following rules:
         1. If the account earned an interest rate for half or more months for the time period being examined, count it as “invested.”
         2. If the account earned an interest rate for less than half the months within the time period being examined, then do not count it as “invested.”
   e. Any dollars moved into an off-balance sheet investment account through a third party advisor are considered to be invested, and are included in both the numerator and denominator of the formula.
   f. Criteria ranges for star ratings:
      i. >95%=5 Stars
      ii. 92.5%-94.99%=4.5 Stars
      iii. 90%-92.49%=4 Stars
      iv. 87.5%-89.99%=3.5 Stars
      v. 85%-87.49%=3 Stars
      vi. 82.5%-84.99%=2.5 Stars
      vii. 80%-82.49%=2 Stars
      viii. 77.5%-79.99%=1.5 Stars
      ix. 75%-77.49%=1 Star
      x. 72.5%-74.99%=0.5 Star
      xi. <72.5%=0 Stars
b. Liquidity Proficiency (Weight=30%)
   a. Refer to FIG. 1
   b. This ratio is calculated by taking the average dollars kept in “long-term related accounts,” and dividing by the average dollars that should have been kept in “long-term related accounts.”
   c. Formula: (Avg. Dollars designated by the entity as “long-term”)/(Avg. Dollars that should have been designated as “long-term”)
      i. “long-term related accounts” refers to money market deposit accounts or separate investment accounts (through an Registered Investment Advisor).
         1. Although money market deposit accounts are overnight funds, we consider them to be “long-term” accounts for entities that have not had a cash flow analysis performed by three+one. Reason being, the funds that are in these accounts tend to remain unchanged for months, if not years at a time.
         2. “Long-term” in this context refers to durations of 1 year and above.
         3. Dollars in these accounts should be viewed and treated by the entity as long-term (greater than 1 year duration) deposits/investments.
      ii. The denominator, a.k.a. “what should have been kept in ‘long-term related accounts,’” is calculated through thousands of cash flow simulations using Monte Carlo techniques.
         1. The goal of the simulations is to use at least 1 year of all prior transaction data gathered through all accounts to determine worst-case scenarios.
         2. “Worst-case scenarios” are generated by simulating future receipts and disbursements based on prior cash flows. The simulations are skewed negatively, so that very conservative estimates are found.
         3. 1 year, 2 year, 3 year, 4 year, and 5 year simulations are run to determine different margins of safety for the client. This is what we refer to as our “stress tests.”
         a. For example, a 5 year stress test threshold of $16 million means that we simulated client cash flow for 5 consecutive years, and we are confident that $16 million will not be needed by the client.
   d. For the initial analysis, three+one counts money market deposits and existing investment accounts as being designated by the entity as “long-term,” even if these dollars aren't viewed as having a duration over 1 year.
   e. For calculations beyond the initial analysis period, only those dollars that have been deposited in a long-term oriented money market account with higher than normal rates, and dollars that are placed in investment accounts with long-term durations, are counted as “long-term” by three+one and used in the numerator of the formula.
      i. Calculations beyond the initial analysis period include new simulations that take into account more recent client data. This can cause the long-term dollar target used in the denominator to shift. Therefore, we use the long-term dollar target set forth in the previous liquidity position score issuance in the denominator. The long-term dollar target revealed through this update will become the denominator in the next quarterly score.
      ii. This prevents an unfair liquidity proficiency ratio being calculated just because the long-term dollar target increased. This would decrease the ratio because the denominator would increase, while the client would have no opportunity to raise their long-term deposits accordingly (and thus increase the numerator as well).
   f. Criteria ranges for star ratings—If the ratio is:
      i. Greater than 1=5 Stars
      ii. 0.9-1=4.5 Stars
      iii. 0.8-0.9=4 Stars
      iv. 0.7-0.8=3.5 Stars
      v. 0.6-0.7=3 Stars
      vi. 0.5-0.6=2.5 Stars
      vii. 0.4-0.5=2 Stars
      viii. 0.3-0.4=1.5 Stars
      ix. 0.2-0.3=1 Star
      x. 0.1-0.2=0.5 Star
      xi. <0.1=0 Stars
c. Warnick Rate Indicator (Weight=20%)
   a. Refer to FIG. 1
   b. This aspect of the score focuses only on annualized yield being earned on dollars identified as “long-term.” This indicator is not influenced by the amount of dollars designated as long-term by the entity, as this is already accounted for in the “Liquidity Proficiency” section described above.
   c. Calculation of the indicator:
      i. Interest rates being earned by the entity are calculated to be an annualized rate on average balances within long-term oriented accounts. For any given period, the calculation of the annualized rate within a particular account is calculated as follows:
         1. (Total interest earned/Total average balance)*(12/number of months being analyzed)
         a. The above formula is annualizing the interest rate calculation using months, but it could be used with days, weeks, quarters, or years.
      ii. A target long-term annualized rate is set by three+one, and this target rate will vary across different entities. three+one takes a number of client specific factors into consideration when setting the target rate for the Warnick rate indicator, including (but not limited to):
         1. What rates we see banks are paying on money market accounts to clients who provide them data produced by three+one.
         2. What rates banks are willing to pay on deposits within the client's geographic region.
         3. What annualized return an RIA has earned on investments of entities similar to three+one's client.
      iii. The target rate is set by three+one in a qualitative manner, considering all possible factors that apply to the client.
      iv. The Warnick Rate Indicator is a percent discount or premium to the target long-term interest rate. Thus, the indicator is calculated as the following:
         1. ((average annualized rate earned on client long-term deposits and/or investments)−(target rate))/(target rate)
   d. Criteria ranges for star ratings—If the calculated indicator is:
      i. Any positive percentage or 0%=5 stars
      ii. −0.01% to −12.49%=4.5 Stars
      iii. −12.5% to −24.99%=4 Stars
      iv. −25% to −37.49%=3.5 Stars
      v. −37.5% to −49.99%=3 Stars
      vi. −50% to −62.49%=2.5 Stars
      vii. −62.5% to −74.99%=2 Stars
      viii. −75% to −87.49%=1.5 Stars
      ix. −87.5% to −94.99%=1 Star
      x. −95% to −99.99%=0.5 Star
      xi. No Interest Earned=0 Stars
d. Cash Flow Optimization (Weight=15%)
   a. Refer to FIG. 1
   b. This part of the score only applies to clients who choose to have a treasury services analysis done on their operations, which is an additional fee on top of the base analysis. three+one will issue a report to the client regarding the findings of the analysis, and recommendations are given of actions to be taken that will improve the efficiency of the organization's cash flow and position. Our recommendations are designed to help our clients realize new sources of savings and revenue.
   c. We give a star rating based upon the percentage of recommendations given that are either in progress or completed. Any cashVest scores issued to a client who has not opted into a treasury services review through three+one will show an “N/A” where the star rating would go for this section. If the client does choose to have a treasury services review, then the initial cashVest score will have an “N/A” for this section, but subsequent score issuances will receive are star rating.
   d. Star ratings are based upon percentage ranges that shift based upon how far removed the client is from the initial presentation of findings and recommendations. three+one determines whether recommendations are being worked towards or have been completed through ongoing communications with the client.
   e. Criteria ranges for star ratings:
      i. Initial cashVest score issuance=“N/A”
      ii. 1^{st} cashVest update
         1. 0-20% of recommendations implemented or being worked towards=1 star
         2. 20.01%-30% of recommendations implemented or being worked towards=2 star
         3. 30.01%-40% of recommendations implemented or being worked towards=3 star
         4. 40.01%-60% of recommendations implemented or being worked towards=4 star
         5. 60.01%-100% of recommendations implemented or being worked towards=5 star
      iii. 2^{nd} cashVest update
         1. 0-20% of recommendations implemented or being worked towards=1 star
         2. 20.01%-30% of recommendations implemented or being worked towards=2 star
         3. 30.01%-40% of recommendations implemented or being worked towards=3 star
         4. 40.01%-60% of recommendations implemented or being worked towards=4 star
         5. 60.01%-100% of recommendations implemented or being worked towards=5 star
      iv. 3^{rd} cashVest update
         1. 0-20% of recommendations implemented or being worked towards=1 star
         2. 20.01%-30% of recommendations implemented or being worked towards=2 star
         3. 30.01%-50% of recommendations implemented or being worked towards=3 star
         4. 50.01%-70% of recommendations implemented or being worked towards=4 star
         5. 70.01%-100% of recommendations implemented or being worked towards=5 star
      v. 4^{th} cashVest update
         1. 0-20% of recommendations implemented or being worked towards=1 star
         2. 20.01%-40% of recommendations implemented or being worked towards=2 star
         3. 40.01%-60% of recommendations implemented or being worked towards=3 star
         4. 60.01%-80% of recommendations implemented or being worked towards=4 star
         5. 80.01%-100% of recommendations implemented or being worked towards=5 star
e. Investment Policy (Weight=10%)
   a. Refer to FIG. 1
   b. The evaluation of the client's Investment Policy Statement is the final aspect of three+one's liquidity position score. It is based upon 4 criteria, 3 of which are specifically defined, while the last incorporates qualitative judgement:
      i. Frequency of policy updates and reviews (10% of the investment policy score, which equates to 1% of the total score)
         1. Criteria for stars:
         a. 1 year or less=5 Stars
         b. 1.01 years-1.5 years=4.5 Stars
         c. 1.51 years-2 years=4 Stars
         d. 2.01 years-2.5 years=3.5 Stars
         e. 2.51 years-3 years=3 Stars
         f. 3.01 years-3.5 years=2.5 Stars
         g. 3.51 years-4 years=2 Stars
         h. 4.01 years-4.5 years=1.5 Stars
         i. 4.51 years-5 years=1 Star
         j. Greater than 5 years=0 Stars
      ii. Number of banks the client permits themselves to do business with (40% of the investment policy score, which equates to 4% of the total score)
         1. Criteria for stars:
         a. List only a few specific banks=1 Star
         b. Within city limits=2 Stars
         c. Within county=3 Stars
         d. Within a few counties=4 Stars
         e. Throughout the state=5 Stars
      iii. Degree of restrictions and/or limits on investment duration (30% of the investment policy score, which equates to 3% of the total score)
         1. Criteria for stars:
         a. Strict limits, money market accounts only (duration of 0 years)=0 Stars
         b. Up to 3 months=0.5 Star
         c. 3 up to 6 Months=1 Star
         d. 6 up to 9 Months=1.5 Stars
         e. 9 up to 1 Year=2 Stars
         f. 1 Year up to 1.5 Years=2.5 Stars
         g. 1.5 Years up to 2 Years=3 Stars
         h. 2 Years up to 2.5 Years=3.5 Stars
         i. 2.5 Years up to 3 Years=4 Stars
         j. Greater than 3 years=5 Stars
      iv. Percent of allowable investments set forth by the entity's state that are permitted within the entity's investment policy statement (20% of the investment policy score, which equates to 2% of the total score)
         1. Every entity should have an investment policy statement that allows all investments permitted by their state (100%). There are some entities though that only permit 50% of the state's allowable investments, and three+one encourages they allow all state permitted investments.
         2. Criteria for stars:
         a. 100% of state permitted investments are allowable within the client's investment policy statement=5 stars
         b. Greater than or equal to 90%=4.5 stars
         c. Greater than or equal to 80%=4 stars
         d. Greater than or equal to 70%=3.5 stars
         e. Greater than or equal to 60%=3 stars
         f. Greater than or equal to 50%=2 stars
         g. Anything less than 50%=1 star
   c. The final star score for the investment policy section of the score is calculated as a weighted average of the 4 unique and separate elements within the section. Consider an entity that is scored the following:
      i. Frequency of policy updates→5 stars
      ii. Number of banks permitted to do business with→4 stars
      iii. Limits on investment duration→3 stars
      iv. Percent of state permitted investments allowable in policy→4 stars
   d. The final calculation of the investment policy section would be as follows:

(5*0.1)+(4*0.4)+(3*0.3)+(4*0.2)=3.8→Round up to 4 stars i.

Once the five sections of the score are calculated, the overall Liquidity Position Score can be issued. The score is calculated as a weighted average of the five elements of the score.

Final score calculation example:
1. Percent of Available Funds Invested—25% Weight: Score of 3 stars
2. Liquidity Proficiency—30% Weight: Score of 4.5 stars
3. Warnick Rate Indicator—20% Weight: Score of 2.5 stars
4. Cash Flow Optimization—15% Weight: Score of 3 stars
5. Investment Policy—10% Weight: Score of 5 stars
Final score calculation:

(0.25*3)+(0.3*4.5)+(0.2*2.5)+(0.15*3)+(0.1*5)=3.55 c.

(3.55/5)*100=71 d.

Additional Commentary Regarding the Calculation of the Liquidity Position Score Although three+one has clearly defined calculations and criteria for issuing a liquidity position score for a client, three+one reserves the right to adjust scoring up or down given any unique circumstances related to the client. The basis for reserving this right is that it is very common to uncover new situations related to a client, that we believe to be relevant to the score, but not common enough to incorporate into the formal scoring system. We will only make changes in instances where we believe an adjustment will improve the integrity of the score.

1. The Liquidity Position Score is a process by which an analyst or analyst(s) evaluating a government entity or higher education entity (the client) can effectively communicate to the client what cash balances are earning an interest rate or earnings credit rate, what balances are available for long-term deposit and/or investment, and what effective interest rate was earned on long-term dollars over a specific time period. In addition, the Liquidity Position score allows an analyst to evaluate progress towards recommended actions set forth by three+one (if applicable), and also determine the appropriateness and effectiveness of client's investment policy statement. First, the analyst should identify every account held by the entity that is earning an interest rate and total each of these interest bearing account's average balance over the time period being studied. This sum should then be divided by the total average cash balance amongst all accounts (both interest and non-interest bearing) over the time period being studied, and the result will be the percent of available funds invested figure. Second, the analyst will use sophisticated Monte Carlo techniques to forecast potential “worst-case” cash flow scenarios to determine what cash balances are available for long-term deposit and/or investment. Next, determine what cash balances on average were being viewed/used by the entity as long-term deposits/investments (i.e. Money Market Accounts, Investment Accounts), and divide this amount by the long-term cash available identified through Monte Carlo simulations. The result will be the ratio used for the liquidity proficiency section of the score. Third, the analyst will calculate the total interest earned by the entity over the time period being studied, and divide it by the average total cash balance amongst all accounts held by the entity. The result is the effective interest rate earned by the entity over the time period being studied, and should then be compared to a target rate (set by the analyst). The percent discount or premium of the calculated effective interest rate to the target rate is the Warnick Rate Indicator. Fourth, if applicable, the analyst should determine through communications with the client, how many of three+one's recommendations have been implemented or are in the process of implementation. The percentage of recommendations that have been implemented or are in the implementation process is identified under the cash flow optimization section. Finally, the investment policy should be reviewed in detail by the analyst to determine how many, if any, critical elements are present in the policy (as explained in detail in the specification). This review will produce the final aspect of the score, labeled “Investment Policy.” Going through these steps to arrive at the final Liquidity Position Score for a client will allow an analyst to effectively evaluate an entity's historical and current cash position, and also communicate these findings to the client.
